(19) United States
(12) Patent Application Publication
(10) Pub. No.: US 2019/0049048 A1
(43) Pub. Date: Feb. 14, 2019

(54) Hose Clamp

(71) Applicants: Gerrit von Breitenbach, Karlstein (DE); Manfred Krüger, Büdingen (DE)

(72) Inventors: Gerrit von Breitenbach, Karlstein (DE); Martin Hielscher, Heilbad Heiligenstadt (DE); Manfred Krüger, Büdingen (DE)

(21) Appl. No.: 16/076,904

(22) PCT Filed: Jan. 10, 2017
(86) PCT No.: PCT/EP2017/050420

§ 371 Date: Aug. 9, 2018

(30) Foreign Application Priority Data
Feb. 9, 2016 (DE) 10 2016 102 197.0

(51) Int. Cl. F16L 33/08; F16B 2/08

(52) U.S. Cl. CPC F16L 33/08; F16B 2/08

(57) ABSTRACT

The present disclosure relates to a hose clamp with a clamp band (1), in which plurality of thread teeth (2) are formed which follow one another at a respective spacing and with which a clamping screw (3) of a clamping device of the hose clamp can be brought into engagement, in order to tension the clamp band (1). The clamping screw (3) has a screw thread (4) with a pitch (p). In order to ensure a reliable engagement of the screw thread with the thread teeth even in the case of small diameters, the spacing of the thread teeth (2) corresponds to an adapted pitch (p′) which is adapted to the pitch (p) of the screw thread (4) in the curved state of the clamp band (1).

### INTRODUCTION

The present disclosure relates to a hose clamp having a clamp band into which are introduced multiple thread teeth which follow one another at a respective spacing and into which a clamp screw of a clamping device of the hose clamp is movable into engagement in order to tension the clamp band, wherein the clamp screw comprises a screw thread with a defined pitch.

DE 197 18 776 C2, for example, discloses an example of a hose clamp having a clamp band into which are introduced multiple thread teeth which follow one another at a respective spacing. In this case, the thread teeth are introduced into the clamp band in the form of free punchings or embossings. The spacings between the individual thread teeth with respect to one another are in each case equal and adapted to the pitch of the screw thread of the clamp screw. However, as the curvature of the clamp band increases, the spacing between the thread teeth changes. Finally, in particular in the case of small diameters, said spacing no longer matches the pitch of the screw thread.

In addition, DE 10 2009 051 128 A1 shows a hose clamp having a clamp band which comprises thread teeth which stand out radially from the clamp band. In particular when the clamp band undergoes a curvature, the spacing between the head sides of the individual radially protruding thread teeth increases. If the clamp band runs into the clamping device, the thread of the clamp screw has thus to engage a new thread tooth of the clamp band with each revolution. If the curvature of the clamp band is too strong, the pitch of the thread of the clamp screw no longer matches the spacing between the thread teeth and the pitch thereof being produced. As a result, damage can occur to the clamp screw and/or to the thread tooth. The tensile force that can be applied by the clamping device into the clamp band is limited by this. Furthermore, the hose clamp can be damaged and re-use become impossible.

The coordination of the thread engagement of a worm drive clamp is therefore effected simply as a result of the thread pitch of the embossed clamp band corresponding to the thread pitch of the clamp screw in the flat state. The bending or rounding of the clamp band results, however, in the spacings between the individual thread teeth with respect to one another changing in dependence on the diameter. In the case of larger bends and consequently smaller diameters of the hose clamp, the spacing between the thread teeth, and consequently the pitch produced, no longer matches the pitch of the clamp screw in the clamping device and in the case of small diameters, the band thread no longer matches the screw thread and is damaged as soon as it runs into the engagement zone of the clamp screw. As a result, the tensile force that can be generated into the clamp band is reduced and consequently the function of the hose clamp is impaired.

### SUMMARY

It is an object of an embodiment of the disclosure to eliminate the disadvantages described and in particular to provide a hose clamp with a clamp band which comprises improved mechanical properties and enables the introduction of high tensile force into the clamp band over large diameter differences. In particular, the mechanical properties of the hose clamp are to be improved.

Said object is achieved proceeding from a hose clamp according to the preamble of claim 1 in conjunction with the recited features. Advantageous further developments of the disclosure are provided in the dependent claims.

The disclosure embraces, in particular, the technical teaching that the spacing between the thread teeth corresponds to an adapted pitch which is adapted to the pitch of the screw thread of the clamp screw in the curved state of the clamp band.

The achievement with the further development according to an embodiment of the disclosure of the hose clamp is that precisely in the case of a curved clamp band, the pitch of the thread teeth largely matches the thread pitch of the clamp screw. Consequently, the disclosure relates, in other words, to a hose clamp with an adapted band thread stamping geometry in the flat band. The thread forming is adapted in the flat state of the clamp band by generating, as a result of bending to the respective clamp diameter, a local band thread pitch, which is situated in the screw engagement and matches the pitch of the clamp screw of the clamping device as best as possible.

The spacing between the thread teeth of the adapted pitch is realized, for example, such that said pitch is smaller in the flat state of the clamp band than the pitch of the screw thread of the clamp screw. If a curvature is introduced into the clamp band, the spacing between the outwardly projecting thread teeth is increased such that the pitch thereof also increases. Said increased pitch only then corresponds to that of the screw thread. In other words, the spacing between the thread teeth in the case of a flatly stretched-out clamp band produces a smaller pitch than the pitch of the screw thread in the case of said example with outwardly directed teeth.

In the case of inwardly directed, embossed teeth, the spacing between the thread teeth of the adapted pitch is preferably realized in such a manner that said pitch is greater in the flat state of the clamp band than the pitch of the screw thread of the clamp screw. The term inwardly directed teeth is to be understood as a realization where the tooth tips lie radially inside the neutral fiber of the clamp band. In the case of outwardly directed teeth, the tooth tips then lie in a corresponding manner radially outside the neutral fiber of the clamp band. When a curvature is introduced, that is to say when the clamp is tensioned, the spacing between the inwardly directed thread teeth is reduced in the case of inwardly embossed teeth such that the resulting pitch is adapted to the pitch of the screw thread of the clamp screw.

A further advantage is provided in an embodiment in that the spacing between the thread teeth corresponds to an adapted pitch which becomes increasingly greater or smaller from thread tooth to thread tooth in a draw-in direction of the clamp band into the clamping device. In other words, with reference to a flatly stretched-out clamp band, as a result the band thread region running into the clamping device first has a larger or smaller pitch spacing than the band thread regions running in thereafter or at the end. An increasingly larger pitch spacing is to be chosen in the case of outwardly directed thread teeth, whilst in the case of inwardly embossed thread teeth an increasingly smaller spacing is to be provided. With an adapted pitch which produces constantly changing spacings between the thread teeth along the clamp band, as the curvature of the clamp band increases, the spacings between the thread teeth adapt to the pitch of the clamp screw over a large adjustment region as the curvature continues. Where the hose clamp has a large diameter and connected thereto a small insertion depth of the clamp band into the clamping device, the spacings between the radially outwardly protruding thread teeth, with reference to a flatly stretched-out band, are even greater. As the draw-in depth of the clamp band into the clamping device increases, the spacing between the thread teeth with respect to one another, with reference to a flatly stretched-out band, then decreases. As a result of the diameter becoming smaller when the hose clamp is tensioned and of the resultant stronger curvature of the clamp band, the spacing between the radially raised thread teeth, however, in particular in the region of the tooth heads, continues to increase further such that a matching of the thread pitches is achieved over the entire adjustment region. In other words, the spacing between the radially raised thread teeth—beginning from the free end of the clamp band—is initially greater and becomes smaller as the path continues in the direction of the oppositely situated end and of the clamping device attached there. The design is precisely reciprocal in the case of radially pressed-in or radially outwardly directed thread teeth.

The disclosure provides, in particular, in this case, that the spacing between adjacent thread teeth with respect to one another changes with a change in pitch. The change in pitch, in this case, is in particular constant or proportional such that the changing spacings according to a first exemplary embodiment are modified by the same amount in each case.

The thread teeth comprise a height h in the flat state of the clamp band, wherein the height h includes a value of between 0.5 mm and 10 mm. The clamp band additionally comprises a neutral fiber NF with a height hNF, to which the following is applicable:

[0-0.5*h]<hNF<h in the case of radially outwardly directed thread teeth and

h<hNF<[h+0.5*h] in the case of radially inwardly directed thread teeth.

This determines the position of the neutral fiber in a corresponding manner, and a correction quotient e of the pitch of the band in the flat state independently of the clamp diameter D is:

e=[D+h−hNF]/[D+hNF].

The adapted pitch of the clamp band in the flat state produced by the correction quotient is consequently

p′=p/e,

wherein p corresponds to the thread pitch of the clamp screw.

The thread teeth can be introduced into the clamp band by means of a punching process or another forming process, wherein the spacings between the thread teeth are predetermined by means of a punching tool. The punching tool can thus work, for example, by rolling the clamp band and can generate the individual thread teeth as a result of notching or as a result of pushing through. In this case, the tool can already predetermine the corresponding spacings between the thread teeth with respect to one another, or in the case of corresponding embossing of the individual thread teeth, the clamp band is moved with the corresponding feed under the tool.

### PREFERRED EXEMPLARY EMBODIMENTS

Further measures which improve the disclosure are shown in more detail below together with the description of a preferred exemplary embodiment of the disclosure by way of the figures, in which:

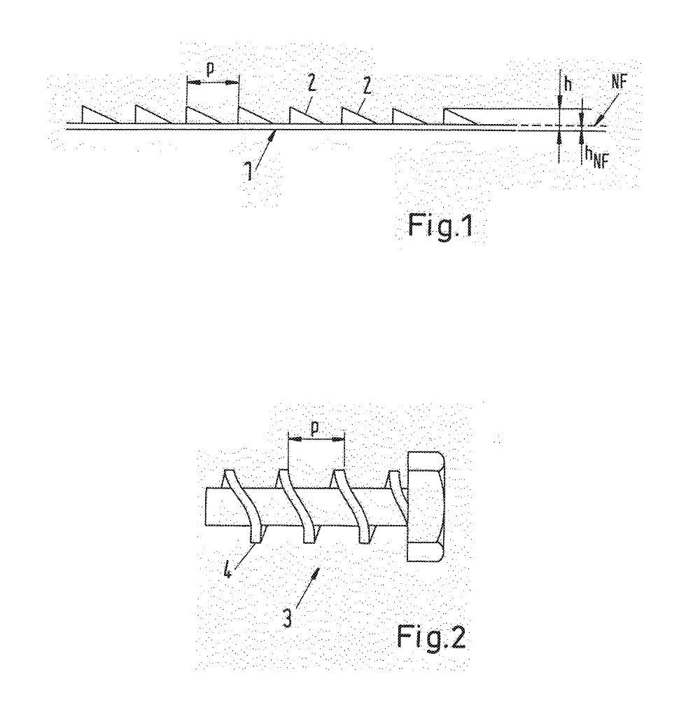

FIG. 1 shows a clamp band of a hose clamp in a flatly stretched-out state with thread teeth which are realized in a conventional manner,

FIG. 2 shows the side view of a clamp screw for a clamping device of a hose clamp,

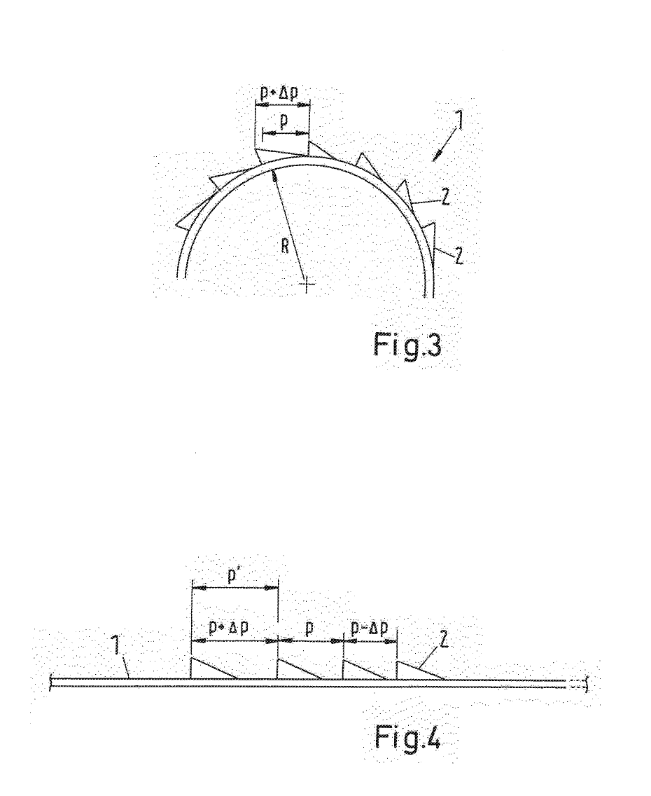

FIG. 3 shows a clamp band in a curved state,

FIG. 4 shows a clamp band with thread teeth, wherein the clamp band is shown in a flat state and wherein the thread teeth are at spacings according to the disclosure with respect to one another which result in a pitch which deviates from the pitch of the clamp screw according to FIG. 2.

FIG. 1 shows a clamp band 1 of a hose clamp according to the prior art in a flat, stretched-out state. Multiple thread teeth 2, which can be produced, for example, as a result of punching-out, notching or the like from the flat clamp band 1, are realized on the top side of the clamp band 1. The individual thread teeth 2 are at a spacing to one another which corresponds to a pitch p. The individual thread teeth 2 are each at an identical spacing to one another such that the pitch p does not change from thread tooth to thread tooth along the clamp band 1.

The thread teeth 2 comprise a height h. In this case, further height specifications are marked.

FIG. 2 shows a clamp screw 3 as is used in a clamping device of a hose clamp. The clamp screw 3 comprises a screw thread 4. The screw thread 4, in this case, has a constant pitch p.

FIG. 3 shows the clamp band 1 according to FIG. 1 (prior art) in an arrangement which is curved with a radius R. The outwardly pointing thread teeth 2, in this case, tower above the clamp band 1 such that the pitch changes by a pitch change Δp when the clamp band is bent. Due to the increasing curvature introduced into the clamp band 1 during tensioning, the spacing between the thread teeth and consequently the actual pitch increases. If the clamp band 1 runs further into the clamping device when tensioned further, the clamp screw 3 is no longer able to engage in the thread teeth 2 in a geometrically precise manner with its unchanged pitch p due to the pitch change Δp taking place.

FIG. 4 shows a clamp band 1 of a hose clamp which has been further developed according to the disclosure. Four thread teeth 2 are shown on the top side of the clamp band 1 as an example.

The two central thread teeth 2 are spaced apart from one another at the pitch p, a spacing between the thread tooth 2 shown on the left-hand side and the second, adjacent thread tooth 2 is increased by the amount of the pitch change Δp such that an adapted pitch p′ is produced. Said design is provided in the case of radially inwardly directed thread teeth, the tips of which lie radially inside the neutral fiber of the curved clamp band.

The third thread tooth 2 comprises a smaller spacing or a smaller pitch with respect to the last, fourth thread tooth 2 which is determined by the pitch p according to the clamp screw 3 minus the pitch change Δp. Said design is used in the case of radially raised thread teeth, the tips of which lie radially outside the neutral fiber of the curved clamp band. The stronger the curvature of the clamp band 1 and the smaller the radius R, the stronger the effect of the extent of the head regions of the thread teeth 2 with respect to one another.

The invention is not restricted in its realization to the preferred exemplary embodiment provided above. Rather, a number of variants are conceivable which use the solution shown even in the case of fundamentally different realizations. All features and/or advantages emanating from the claims, the description or the drawings, including structural details or spatial arrangements, can be essential to the invention both in their own right and also in the various combinations.

1. A hose clamp having a clamp band into which are introduced multiple thread teeth which follow one another at a respective spacing and into which a clamp screw of a clamping device of the hose clamp is movable into engagement in order to tension the clamp band, wherein the clamp screw comprises a screw thread with a pitch (p), and wherein the spacing between the thread teeth corresponds to an adapted pitch (p′) which is adapted to the pitch (p) of the screw thread in a curved state of the clamp band.

2. The hose clamp as claimed in claim 1, wherein the adapted pitch (p′) is unequal, in particular is smaller or greater than the pitch (p) of the screw thread, in a flat state of the clamp band.

3. The hose clamp as claimed in claim 1, wherein the adapted pitch (p′) becomes increasingly greater or smaller from thread tooth to thread tooth in a draw-in direction of the clamp band into the clamping device.

4. The hose clamp as claimed in claim 1, wherein the spacing between adjacent thread teeth with respect to one another changes with a correction quotient.

5. The hose clamp as claimed in claim 4, wherein the correction quotient changes in dependence on a run-in depth of the clamp band into the clamping device.

6. The hose clamp as claimed in claim 1, wherein the thread teeth comprise a height (h) in a flat state of the clamp band, wherein the height (h) includes a value of between 0.5 mm and 10 mm.

7. The hose clamp as claimed in claim 6, wherein the clamp band comprises a neutral fiber (NF) with a height (hNF), to which the following is applicable: [0-0.5*h]<hNF<h or h<hNF<[h+0.5*h].

8. The hose clamp as claimed in claim 1, wherein the thread teeth are introduced into the clamp band by means of a forming process, in particular by means of an embossing process or deep drawing process, wherein the spacings between the thread teeth are predetermined in particular by means of an embossing or deep drawing tool.
